(19) United States
(12) Patent Application Publication
(10) Pub. No.: US 2014/0021146 A1
(43) Pub. Date: Jan. 23, 2014

(54) HOUSING FOR A SINGLE-USE BAG FILTER

(71) Applicants: Rheinisch-Westfälische Technische Hochschule Aachen, Aachen (DE); Fraunhofer Gesellschaft zur Foerderung der angewandten Forschung e.V., Muenchen (DE)

(72) Inventor: Johannes Felix Buyel, Erkelenz (DE)

(21) Appl. No.: 13/943,288

(22) Filed: Jul. 16, 2013

Related U.S. Application Data
(60) Provisional application No. 61/672,873, filed on Jul. 18, 2012.

(30) Foreign Application Priority Data
Jul. 18, 2012 (EP) 12176847.7

(51) Int. Cl. B01D 29/00

(52) U.S. Cl. CPC B01D 29/0031; B01D 29/0029
USPC 210/770; 210/435

(57) ABSTRACT

The invention refers to a housing for a single-use bag filter for filtering dispersed particles from a turbid solution that must not come into contact with the environment of the filter, characterized in that the housing is designed as a single-use housing destined for disposal after having been used once. The invention is further directed to a method for squeezing out a used flexible single-use bag filter.

### CROSS-REFERENCE TO RELATED APPLICATIONS

This Application claims priority to European Patent Application No. 12176847.7, filed Jul. 18, 2012, and to U.S. provisional patent application No. 61/672,873, entitled “Housing for a disposable bag filter,” filed Jul. 18, 2012, both of which are incorporated herein by reference.

The invention refers to a housing for a single-use bag filter for filtering dispersed particles from a turbid solution that must not come into contact with the environment of the filter.

Filtering dispersed particles from a turbid solution may be necessary e.g. in the production of pharmaceutics. Here, it may happen that the filtration product must not come into contact with substances from previous processes or with the environment. The solution to be filtered may, for instance be, a radioactively solution or a sludge. Further, it may be a potentially infectious material. In the production of pharmaceutics, these may also be protein-containing solutions. The solution may further contain a high level of solids and may be a plant extract, for example.

Before being processed or disposed, such turbid solutions often have to be freed from dispersed particles, since these substances may cause problems in later process steps. Among others, one of these problems is the clogging of columns for chromatographic separation of the contents. An effective and economic method for removing particles, which is known from prior art, is bag filtration. For this purpose, bag filters are placed in corresponding holders. After the useful filter life has reached its end, mostly after a single use, the filters are disposed. In contrast thereto, the holders are often made from stainless steel or similar materials and are designed for long-term use. Therefore, they have to be cleaned regularly. When used in biopharmaceutic production, cleaning these housings causes great labor and documentation efforts. For one, it has to be ensured that no residues can be transferred from a terminated process to a subsequent process. On the other hand, it has to be ensured that, during the cleaning of the housing, no potentially infectious or genetically engineered material is released into the environment.

Presently, holders for the filters described are cleaned using chemicals, such as concentrated caustic soda, some of these chemicals being aggressive.

It is an object of the invention to provide a housing for a single-use bag filter for filtering dispersed particles from a turbid solution, which is simple to manufacture and simple to use.

The object is achieved according to the invention with the features of claim 1.

The housing of the invention receives a single-use bag filter, through which dispersed particles are filtered from a turbid solution that must not come into contact with the environment of the filter.

According to the invention, the housing is designed as a single-use housing destined for disposal after having been used once. In the present context, a single-use housing is understood, in particular, to be a flexible housing having a wall thickness of 0.5 to 3.0 mm and, in particular, of 1.0 to 1.5 mm. Such a housing can be made of a plastic material, for instance, and therefore differs from multiple-use housings that are typically made of stainless steel. Preferably, the plastic material is biodegradable.

Thus, according to the invention, the tedious cleaning of the filter housing can be omitted. Further, it is ensured in a very simple manner that no substances get from a previous process into a later process in which the same filter housing is used. Thereby, the safety and the quality of the product, namely of the filtrate, can be enhanced.

It is preferred that the single-use bag filter is formed integrally with the single-use housing. The single-use housing is thus supplied complete with the single-use bag filter and can be used as a unit to perform filtration. After the termination of the filtration, the single-use housing is disposed together with the single-use bag filter. Disposal may be effected, for example, by combustion or autoclaving.

As an alternative, it is possible that the single-use housing and the single-use bag filter are designed in two-part fashion. In this respect, the single-use housing comprises a fastening device for fastening a conventional single-use bag filter inside the single-use housing. This fastening device can be designed such that bag filters of a certain size can be fixed inside the housing. Alternatively, a fastening adapter can be used which may in particular be exchangeable. It is possible by means of this adapter to fasten single-use bag filters of different manufacturers and/or sizes in the single-use housing. Thus, the single-use filter housing of the invention offers the possibility to use any bag filter available on the market, without a time-consuming cleaning of the housing being required. Thereby, a change of the filter manufacturer is no longer required, which change could pose a problem, for example, in heavily regulated processes for the production of biopharmaceutics. The modular structure consisting of a separate single-use housing and a separate single-use bag filter is a substantial advantage over the solutions known from prior art, since, in these known solutions, it has to be defined already in the manufacturing process which filter is to be used. An adaptation to a desired filter type, e.g. also with respect to particular filter characteristics, is no longer possible at a later moment.

It is preferred that the single-use housing has a flexible outer wall and further comprises at least one stiffening element to stiffen the flexible outer wall. The outer wall may be made from an at least partly transparent plastic material, for example. Preferably, the flexible outer wall is of a thin-walled design and has material-dependent strength suited for an operating pressure of about 2 to 20 bar above ambient pressure. This enables a particularly low-cost manufacture of the filter housing. In the embodiment mentioned, the outer wall of the housing thus does not serve to stiffen the housing. This task is met by a separate stiffening element. The same may be, for instance, a rigid inlet cap, the fabric of the bag filter itself, a spreading ring at at least one end of the flexible outer wall and/or a rigid filter basket surrounding the bag filter and arranged between the same and the flexible outer wall.

The stiffening element may further be a rigid, in particular tubular outer housing into which flexible single-use housings and the flexible single-use bag filter are inserted for performing filtration. For example, the inlet cap may have a thread for this purpose, which can be threaded into another thread in the tubular outer housing. Similar to an exo-skeleton, the rigid outer housing can absorb the majority of the working pressure so that it becomes possible to manufacture the flexible single-use housing with even thinner walls. The rigid outer housing would thus be reusable, similar to the housings known from prior art. However, in this embodiment, the rigid outer housing does not come into contact with the solution to be filtered so that it is not contaminated. Between the rigid outer housing and the single-use bag filter and the solution, the flexible single-use housing is arranged that prevents contamination of the rigid outer housing.

After filtration has been performed, it is possible to remove the flexible single-use housing, including the flexible single-use bag filter contained therein, from the rigid outer housing.

Within the framework of a method according to the invention, the single-use bag filter in the flexible single-use housing can then be squeezed after use, whereafter the residual liquid still contained therein can thereafter be recovered. Squeezing is done by applying an external force on the single-use housing by means of a squeezing device, in particular by squeeze rollers. Here, the squeezing device merely contacts the outer side of the single-use housing, not, however, the single-use bag filter or the solution to be filtered itself. The squeezing method described can also be used independently of the illustrated embodiment having the rigid outer housing.

The filter basket may be welded to the bottom end of the inlet cap, for example, or it may be formed integrally therewith. The filter basket serves to support the fabric of the filter at high operating pressures, in order to thereby prevent a possible tearing of the filter fabric. Further, a direct contact of the outer wall of the housing and the filter is avoided by virtue of the filter basket. This ensures an undisturbed filtration process, since an abutment of the filter against the outer wall of the housing would reduce the passage surface, thereby causing a lower filtering performance.

The spreading ring can be provided at the lower end of the flexible outer wall, for example, and may be made from plastic material, metal or rubber. This can also help to prevent the above described abutment of the filter fabric against the outer wall. The spreading ring may also be situated outside the flexible outer wall and may be connected with the same by lugs, for example. Thereby, a space-saving transport and a simpler manufacture become possible.

It is preferred that the single-use housing has an inlet and an outlet for letting the solution to be filtered in and out thereof. The inlet and/or outlet can be closable by means of a closure device, such that after the filtration has been performed, no solution can escape outward from inside the single-use housing. The closure device may be a stopcock or a valve, for example.

The inlet and the outlet can be a tri-clamp, for example. In the region of the inlet cap and/or the outlet, additional ports can be provided, e. g. for pH probes, venting valves or the like.

The inlet cap can be welded at its bottom end to the fabric of the bag filter. The inlet cap, the bag filter and the weld seam are designed such that they can withstand a required maximum operating pressure. The maximum operating pressure may vary depending on the application and typically is about 2 to 10 bar above ambient pressure. The flexible outer wall of the housing can also be welded to the inlet cap and also to the outlet housing.

In an alternative embodiment, the single-use housing has a two-part inlet cap, with the upper part of the inlet cap flaring towards the bag filter and widening into a disc. The inlet side of the inlet cap lower part is also of disc-shaped design and comprises an in particular annular recess or another fastening device for fastening a conventional single-use bag filter.

In this embodiment, it is preferred that the disc-shaped inlet cap upper part and the lower part thereof have a recess in which a seal is received.

Further, in this embodiment, the inlet cap upper part and the lower part thereof can be connected mechanically by means of a connecting device, in particular a clamp, (wing) screws, clip or the like, so that the seal and the single-use bag filter is fixed between the same.

Both parts of the inlet cap are preferably made from plastic material, in order to keep production costs low. However, metals and other materials can also be used. The inlet cap upper part of the described embodiment can be designed as a reusable part and thus is not a part of the single-use housing in this embodiment.

The inlet cap of the housing can widen towards the bag filter and may particularly be of a conical or dome shape. When using an adapter that allows the use of different conventionally available bag filters, the inlet cap does not have to be exchanged. Rather, the use of the various filter types merely requires a change of the adapter.

The following is a detailed description of preferred embodiments of the invention with reference to the Figures.

In the Figures:

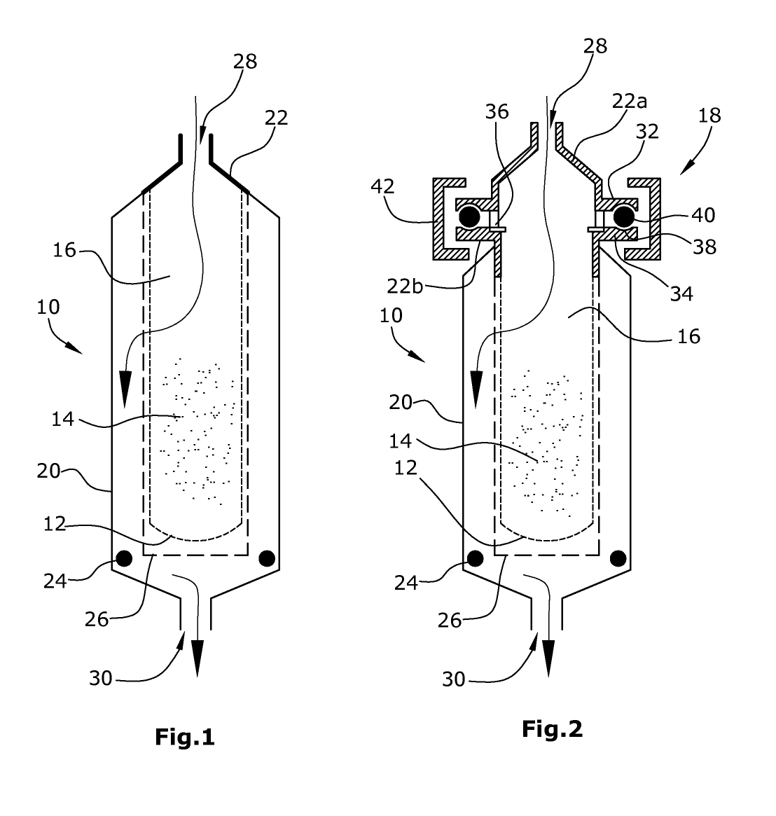

FIG. 1 shows a first embodiment of the device according to the present invention,

FIG. 2 shows a second embodiment of the device according to the present invention.

As illustrated in FIG. 1, the single-use housing 10 is formed integrally with the single-use bag filter 12. Between the bag filter 12 and the outer wall 20 of the housing 10, a rigid filter basket 26 is arranged. In the present context, rigid is to be understood as the filter basket being more rigid than the flexible outer wall 20 and can thus contribute to the stiffening of the same. The same is true for the other stiffening elements, such as the spreading ring 24, the rigid inlet cap 22 or the fabric of the single-use bag filter 12 itself.

In the context of filtration, the solution 16 to be filtered is supplied to the inside of the housing 10 via the inlet 28. The particles 14 contained in the solution 16 are retained by the filter 12, while the filtrate leaves the housing 10 via the outlet 30 and is transported away for further processing.

The embodiment in FIG. 2 differs from the embodiment in Fig. I in that the filter housing 10 and the single-use bag filter 12 are of a two-part design. In this respect, the inlet cap 22 is of a two-part design and comprises an inlet cap upper part 22a and an inlet cap lower part 22b. The inlet cap upper part 22a widens from the inlet 28 towards the bag filter 12, so that it is disc-shaped in its lower portion 32. Correspondingly, the inlet cap lower side 22b is also disc-shaped in the portion 34 facing the inlet. In this portion 34, the inlet cap lower side 22b has a recess 38 which receives a seal 40 by which the housing 10 is closed hermetically against the outside. The inlet cap upper side 22a may have a similar recess.

Further, the inlet cap lower side 22b comprises a fastening device for fastening the bag filter 12 inside the housing 10, the device starting from the seal 40 in a radially inward direction and formed as a second recess 36.

The inlet cap upper side 22a and the inlet cap lower side 22b are mechanically connected by means of a clamp 42 so that the seal 40 and the single-use filter 12 are fixed between them. The reference numeral 18 identifies the fastening device that serves to fasten a conventional single-use bag filter 12 inside the single-use housing and which comprises the discs 32, 34 and the clamp 42.

What is claimed is:

1. A housing for a single-use bag filter for filtering dispersed particles from a turbid solution that must not come into contact with the environment of the filter, characterized in that
the housing is designed as a single-use housing destined for disposal after having been used once.

2. The housing for a single-use bag filter of claim 1, characterized in that the single-use bag Filter is formed integrally with the single-use housing.

3. The housing for a single-use bag filter of claim 1, characterized in that the single-use housing comprises a fastening device, in particular an exchangeable fastening adapter, for fastening a conventional single-use bag filter inside the single-use housing, wherein in particular single-use bag filters of different manufacturers and/or sizes can be fastened in the single-use housing.

4. The housing for a single-use bag filter of claim 1, characterized in that the single-use housing comprises a flexible outer wall and further comprises at least one stiffening element for stiffening the flexible outer wall, wherein the stiffening element is, in particular, a rigid inlet cap, the fabric of the bag filter, a spreading ring at at least one end of the flexible outer wall, a rigid, in particular tubular outer housing and/or a rigid filter basket surrounding the bag filter and arranged between the same and the flexible outer wall.

5. The housing for a single-use bag filter of claim 1, characterized in that the single-use housing has an inlet and an outlet to let the solution to be filtered in and out, wherein the inlet and/or the outlet are closable by means of a closure device such that after filtration has been performed, no solution can escape outward from inside the single-use housing.

6. The housing for a single-use bag filter of claim 1, characterized in that the single-use housing comprises a two-part inlet cap, wherein the inlet cap upper part flares in the direction of the bag filter and widens into a disc, and the inlet side of the inlet cap lower part is also disc-shaped and comprises an in particular annular recess for fastening a conventional single-use bag filter.

7. The housing for a single-use bag filter of claim 6, characterized in that the disc-shaped inlet cap upper part and the inlet cap lower part comprise a recess in which a seal is received.

8. The housing for a single-use bag filter of claim 6, characterized in that the disc-shape inlet cap upper part and the inlet cap lower part are connected mechanically by means of a clamp so that the seal and the single-use bag filter are fixed therebetween.

9. The housing for a single-use bag filter of claim 1, characterized by an inlet cap flaring in the direction of the bag filter and being in particular of a conical or dome shape.

10. A method for squeezing out a used flexible single-use bag filter arranged in a flexible single-use housing, characterized by the step of:
squeezing out the single-use bag filter in the flexible single-use housing after use, wherein the squeezing is done by applying an external force on the single-use housing by means of a squeezing device, in particular by squeeze rollers, wherein the squeezing device merely contacts the outer side of the single-use housing, not, however, the single-use bag filter or the solution to be filtered.
